(19) United States
(12) Patent Application Publication
(10) Pub. No.: US 2026/0235294 A1
(43) Pub. Date: Aug. 13, 2026

(54) TEMPERATURE-ADJUSTING ELECTRIC RANGE

(71) Applicant: Seong Cheol MOON, Gwacheon-si, Gyeonggi-do (KR)

(72) Inventor: Seong Cheol MOON, Gwacheon-si, Gyeonggi-do (KR)

(21) Appl. No.: 19/158,980

(22) PCT Filed: Feb. 24, 2023
(86) PCT No.: PCT/KR2023/002685

§ 371 Date: Aug. 22, 2025

(51) Int. Cl. F24C 7/08; F24C 15/00

(52) U.S. Cl. CPC F24C 7/082; F24C 7/087; F24C 15/006

(57) ABSTRACT

The present invention relates to a temperature-adjusting electric range for a cooking device, in which one or more fixed or movable temperature detection sensors are installed in a single upper plate so as to be away from a heat source part and be at positions on the same level as or higher than the single upper plate or a separated upper plate, thereby contacting a cooking vessel so as to detect the temperature of the cooking vessel, and an adjustment part analyzes or predicts said temperature so as to adjust the heat power of the heat source part and the temperature of the cooking vessel. The present invention is a technique for adjusting the temperature of a cooking vessel by positioning, in the electric range, the temperature detection sensors away from the heat source part, and not at the center of the heat source part, thereby securing temperature accuracy and preventing overflowing food from entering into the electric range.

### TECHNICAL FIELD

The present invention relates to an electric range for a cooking device that adjusts a temperature.

### BACKGROUND ART

An electric range is a cooking device that heats a cooking container using an induction type or a heating wire type heat source.

An electric range is a device that performs cooking in a state in which a heat source part that is a heating means such as a working coil is provided, a heat-resistant upper plate is disposed on the heat source part, and the cooking container is plated on the upper plate, and the use thereof is increasing.

An electric range has a smooth surface and is easy to clean because a single heat-resistant material upper plate is used but is difficult to adjust a temperature of the cooking container. In actual electric ranges on the market, an overheating detection sensor that prevents overheating by detecting overheating of the heat source part is installed in a center of the heat source part under the upper plate, but few electric ranges are equipped with temperature detection sensors that directly detect the temperature of the cooking container.

A structure that directly measures the temperature of the cooking container through a temperature detection sensor in an electric range should ensure temperature accuracy of the cooking container and needs to prevent or cope with inflow of overflowing food into an interior thereof.

When the temperature detection sensor is disposed in a heating area such as a center of the heating area, the following matters may be of concern.

First, it is not easy to accurately measure the temperature of the cooking container because the temperature detection sensor is surrounded by the heat source part and a temperature of the temperature detection sensor changes due to excessive heat conduction through the cooking container. Further, a proper position of the overheating detection sensor in the center of the heating area should be considered.

Second, the food overflowing from the cooking container may penetrate into a body through a minute gap between the temperature detection sensor and the upper plate and thus contaminate the inside of the body. To cope with this case, a water storage container or a drain is provided below the temperature detection sensor to discharge an inflow food to the outside of the device. In Korean Patent Registration No. 10-2346115, the temperature detection sensor is disposed through the upper plate of the heating area on which the cooking container is seated, and the inflow food is stored and is evaporated using a cooling fan. However, even when the cooling fan evaporates the stored food, water is evaporated, but cooking contents may remain in the water storage container.

Further, when a single temperature detection sensor is installed on a single upper plate, the entire cooking container bottom is not flat, a central portion thereof may be concave or convex, and thus contact with the temperature detection sensor may not be good. In consideration of this case, in general, in the temperature detection sensor, an elastic member is included to move a body part, and a sensor unit is installed to be higher than the upper plate. When the cooking container is placed on the upper plate, the cooking container comes into contact with the upper plate, the elastic member of the temperature detection sensor is contracted, and the cooking container comes into contact with the temperature detection sensor. In this manner, there is a gap because the temperature detection sensor moves, and the overflowing food may penetrate into the body through this gap.

In consideration of this point, in the electric range according to the present invention, the single upper plate is divided into an area of the heat source part and an area outside the heat source part, a separate upper plate is divided into an upper plate above the heat source part and an upper plate outside the heat source part, and the temperature detection sensor is installed in the area outside the heat source part or the upper plate. The separate upper plate may be de-inducted or de-highlighted. When two temperature detection sensors are installed on a straight line in an area outside the heat source part, at the same height as the upper plate, or at a position slightly higher than the upper plate or three or more temperature detection sensors are installed on the upper plate outside the heat source part in a polygonal shape, even when a central portion of the cooking container bottom is not flat but concave or convex, the cooking container bottom is in contact with the one or more temperature detection sensors. In this case, the temperature detection sensor may be fixed to the area or the upper plate to remove the gap or prevent the inflow of the moving but overflowing food into an interior thereof so that the interior is not contaminated with the food. In particular, in a structure of the separate upper plate, only the separate upper plate, which is an upper portion of the heat source part, may be made of expensive heat-resistant glass, the other plates may be made of relatively cheap materials, and thus material costs are reduced. Further, less of the overflowing food reaches the hot separate upper plate, the amount of carbonized and deposited overflowing food is greatly reduced, and thus cleaning also becomes easier.

An adjustment unit of the electric range analyzes or predicts a measured temperature of the cooking container to adjust heating power of the heat source part and the temperature of the cooking container. In addition, the adjustment of the temperature of the cooking container copes with the overflow of the food before or after it happens.

The present invention is a technology for adjusting the temperature of the cooking container by positioning the temperature detection sensor outside the heat source part rather than in the center of the heat source part, securing temperature accuracy, and preventing inflow of the overflowing food in the electric range.

### DETAILED DESCRIPTION OF INVENTION

### Technical Problem

In the present invention, in an electric range, a temperature detection sensor is positioned outside a heat source part, heating power of the heat source part and a temperature of a cooking container are adjusted by directly measuring the temperature of the cooking container, the accuracy of a temperature of the cooking container is improved, and overflowing food is prevented from flowing into an interior thereof.

### Technical Solution

According to the present invention, this purpose and additional purposes are implemented in a temperature-adjusting electric range for a cooking device by integrating the features disclosed in independent claims and simply by technical means described below as a non-limiting example with reference to the accompanying drawings.

### Advantageous Effects

An effect of the present invention is improving the accuracy of a temperature of a cooking container measured while positioning a temperature detection sensor at a position outside the heat source part.

Another effect of the present invention is preventing an inside of a body from being contaminated by overflowing food by removing a gap between the temperature detection sensor and the upper plate or preventing inflow of the food.

Another effect of the present invention is directly measuring a temperature of the cooking container and adjusting heating power of the heat source part and the temperature of the cooking container, thereby promoting convenience of use the electric range.

Another effect of the present invention is reducing material costs by using a separate upper plate and reducing the amount of carbonized and deposited overflowing food, thereby improving cleaning properties.

### DESCRIPTION OF DRAWINGS

FIG. 1 is an exemplary view of an electric range currently in use.

FIG. 2 is a cross-sectional view of an electric range having a single upper plate and two fixed temperature detection sensors according to an embodiment of the present invention.

FIG. 3 is a cross-sectional view of an electric range having a separate upper plate and two fixed temperature detection sensors according to an embodiment of the present invention.

FIG. 4 is a cross-sectional view of an electric range having a separate upper plate and two movable temperature detection sensors according to an embodiment of the present invention.

FIG. 5 is a cross-sectional view of an electric range having a separate upper plate and one fixed temperature detection sensor according to an embodiment of the present invention.

FIG. 6 is a plan view of an inclined electric range having a separate upper plate and a fixed temperature detection sensor according to an embodiment of the present invention.

### MODES OF THE INVENTION

The present invention illustrates specific embodiments in the drawings and describes specific details for implementing the present invention in detail. However, it should be understood that the present invention is not limited to the specific embodiments and includes all changes, equivalents, and substitutions included in the spirit and scope of the present invention. In describing the drawings, similar reference numerals are used for similar components.

Unless otherwise defined, all terms used herein including technical or scientific terms have the same meanings as those commonly understood by those skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

The present invention is applied to an electric range using an induction type or a heating wire type heat source.

The electric range uses a single upper plate rather than two or more pieces that are usually coupled or separated. In the electric range of the present invention, one or more temperature detection sensors are installed, and thus a single or separate upper plate is used. The electric range of the separate upper plate is obtained by separating an upper plate on the heat source part from the single upper plate and thus may be referred to as de-induction or de-highlight.

Next, an invention related to adjustment of a temperature of a cooking container in the electric range will be described with reference to the accompanying drawings.

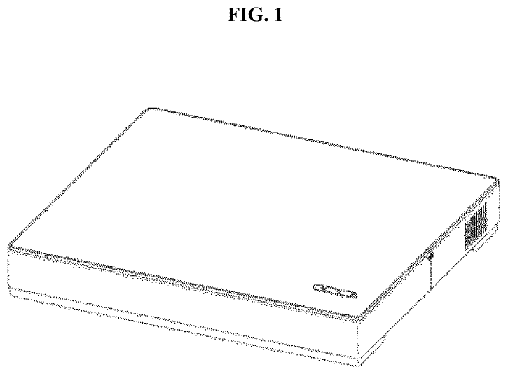

FIG. 1 is an exemplary view of an electric range currently in use.

As illustrated in FIG. 1, the single upper plate is used. In the related invention, a sensing hole and a sensor unit are arranged in a heating area of the single upper plate.

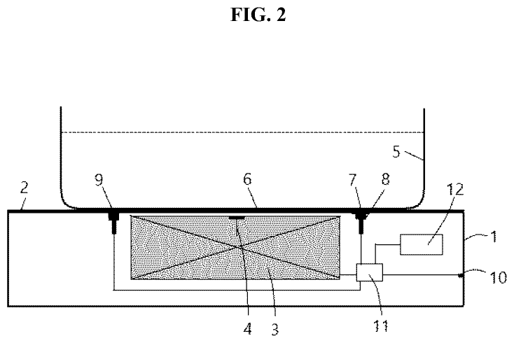

FIG. 2 is a cross-sectional view of an electric range having a single upper plate and two fixed temperature detection sensors according to an embodiment of the present invention.

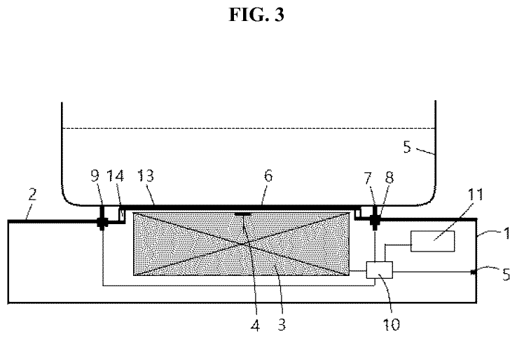

FIG. 3 is a cross-sectional view of an electric range having a separate upper plate and two fixed temperature detection sensors according to an embodiment of the present invention.

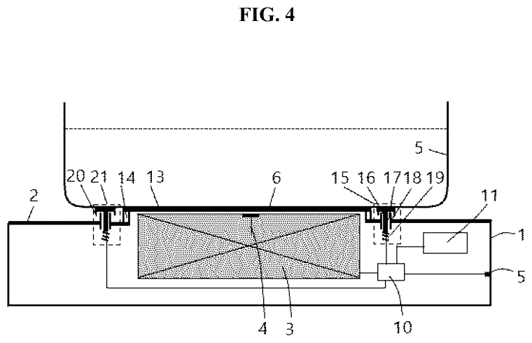

FIG. 4 is a cross-sectional view of an electric range having a separate upper plate and two movable temperature detection sensors according to an embodiment of the present invention.

The electric range includes a body 1 that has a frame and has an installation space therein, a first upper plate 2 that covers the body 1, a heat source part 3 that is disposed under the first upper plate 2 and heats a cooking container bottom 6, and a cooling fan (not illustrated) that is disposed under the first upper plate 2 and cools insides of the heat source part 3 and the body 1. The heat source part 3 operates in an induction manner or a heating wire manner. An overheating detection sensor 4 disposed under the first upper plate 2 at a center of the heat source part 3 prevents heat from the cooking container bottom 6 from being conducted through the first upper plate 2 and overheating the heat source part 3. That is, when the overheating detection sensor 4 reaches a certain temperature, an adjustment unit 11 cuts off electric power of the heat source part 3.

In FIG. 2, the first upper plate 2 includes one plate as the single upper plate, is made of a high heat-resistant material such as ceramic or heat-resistant glass to prevent deformation and damage due to a temperature of the cooking container bottom 6, and covers the body 1.

In FIGS. 3 and 4, the separate upper plate is an upper plate separated into the first upper plate 2 and a second upper plate 13 obtained by separating an upper plate on the heat source part 3 from the first upper plate 2 and positioning the separated upper plate at the same height as or a higher position than the first upper plate 2. The first upper plate 2 is not a high-temperature area and thus is made of a metal, tempered glass, and a heat-resistant or high-heat-resistant material, and the second upper plate 13 is made of a high-heat-resistant material such as ceramic or heat-resistant glass to prevent deformation and damage due to the temperature of the cooking container bottom 6. Here, when only the second upper plate 13 is made of an expensive high heat-resistant material and the first upper plate 2 is made of another material, material costs can be reduced. The first upper plate 2 and the second upper plate 13 are coupled to each other by an upper plate coupling member 14 to prevent overflowing food from flowing into the body 1 and cover the body 1. A shape of the upper plate coupling member 14 may have any structure as long as the structure prevents penetration of food between the first upper plate 2 and the second upper plate 13, and a material thereof may be synthetic rubber, natural rubber, a non-metallic material, or a metal. In particular, in the separate upper plate, since the overflowing food starts to directly fall from a cooking container 5 to the first upper plate 2 before reaching the second upper plate 13, the overflowing food does not reach the second upper plate 13 or less overflowing food reaches the second upper plate 13, and the amount of carbonized and deposited overflowing food is greatly reduced, thereby facilitating cleaning.

The positions and number of the temperature detection sensors are important factors for temperature accuracy in the electric range that adjusts a temperature of the cooking container.

When the temperature detection sensor is positioned at the center of the heat source part, the temperature detection sensor is surrounded by the heat source part, and the temperature of the temperature detection sensor changes due to excessive heat conduction through the cooking container. Thus, it is not easy to accurately measure the temperature of the cooking container according to a size and material of the cooking container. Further, a proper position of the overheating detection sensor disposed in the center of the heating area should be considered.

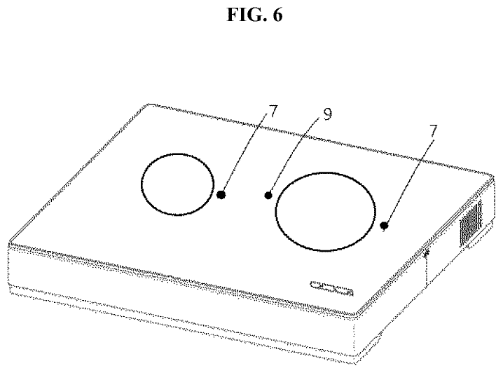

Considering this point, when the temperature detection sensors 7, 9, 15, and 21 are installed on the first upper plate 2 that is provided outside two heat source parts 3 in a straight line as illustrated in FIG. 6 at the same height as or a higher position than the first upper plate 2 or the second upper plate 13 or three or more heat source parts 3 in a polygonal shape at regular intervals, even when a central portion of the cooking container bottom 6 is not flat but concave or convex, the cooking container bottom 6 is in close contact with the one or more temperature detection sensors 7, 9, 15, and 21. In this case, the temperature detection sensors 7, 9, 15, and 21 may be fixed to the first upper plate 2 in a sealed state or a food inflow preventing bank 18 may be installed, so that a gap can be removed or inflow can be prevented. Further, there is no need to move the overheating detection sensor in the center of the heating area.

The types of the temperature detection sensors 7, 9, 15, and 21 and mutual assembly with the upper plate are considered to prevent the overflowing food from flowing into the body 1.

The two or more fixed temperature detection sensors 7 and 9 of FIGS. 2 and 3 are fixedly installed at the same height as or a higher position than the first upper plate or the second upper plate 13 while passing through the first upper plate 2 at a position outside the heat source part 3 and detect a temperature of the cooking container 5 while in contact with the cooking container bottom 6. The fixed temperature detection sensors 7 and 9 are directly and fixedly sealed so that there is no gap with the first upper plate 2 or are fixedly sealed by inserting an inflow preventing member 8 between the fixed temperature detection sensors 7 and 9 and the first upper plate 2. The inflow preventing member 8 is installed to prevent penetration of the overflowing food. A shape of the inflow preventing member 8 may have any structure as long as the structure may prevent penetration of the food between the fixed temperature detection sensors 7 and 9 and the first upper plate 2, and a material thereof may be synthetic rubber, natural rubber, a non-metallic material, or a metal.

The movable temperature detection sensors 15 and 21 of FIG. 4 are installed to move while passing through the first upper plate 2 at a position outside the heat source part 3 and protruding from the first upper plate 2 or the second upper plate 13 and detect the temperature of the cooking container 5 while in contact with the cooking container bottom 6. When the cooking container 5 is placed on the first upper plate 2 or the second upper plate 13, an elastic member 19 is contracted, and thus the movable temperature detection sensors 15 and 21 come into contact with the cooking container bottom 6. The movable temperature detection sensors 15 and 21 include a sensor unit 15 that detects the temperature of the cooking container bottom 6, a body part 16 that maintains the sensor unit 15 and guides the movement, the food inflow preventing bank 18 that prevents the overflowing food from flowing into the body 1, and the elastic member 19 that is contracted by a weight of the cooking container. In the movable temperature detection sensors 15 and 21, a vertical eave 20 is attached to an edge of the sensor unit 15, the vertical eave 20 covers the food inflow preventing bank 18 like a cap, and thus the overflowing food flows to the first upper plate 2 and does not flow into the body 1.

In this way, two or more of the temperature detection sensors 7, 9, 15, and 21 are fixedly installed at the same height as or a higher position than the first upper plate 2 or the second upper plate 13 while passing through the first upper plate 2 at a position outside the heat source part 3 or two or more thereof are movably installed to protrude from the first upper plate 2 or the second upper plate 13 and thus detect the temperature of the cooking container 5 while in contact with the cooking container 5. As described in the embodiments, a temperature-adjusting electric range may include a combination of the two or more fixed temperature detection sensors or the two or more movable temperature detection sensors on the single upper plate or the separate upper plate. In the drawing, there is no combination of the single upper plate and the two or more movable temperature detection sensors, but this is possible as an embodiment.

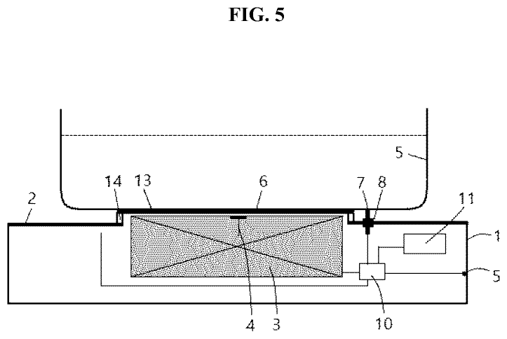

FIG. 5 is a cross-sectional view of an electric range having a separate upper plate and one fixed temperature detection sensor according to an embodiment of the present invention.

In terms of temperature accuracy of the cooking container, it is preferable that two or more temperature detection sensors be installed. However, only one temperature detection sensor is fixedly installed at the same height as or a higher position than the first upper plate or the second upper plate while passing through the first upper plate 2 at a position outside the heat source part 3 or only one temperature detection sensor is movably installed to protrude from the first upper plate 2 or the second upper plate 13 and thus detects the temperature of the cooking container 5 while in contact with the cooking container bottom 6. In this way, the temperature-adjusting electric range may include a combination of the one fixed temperature detection sensor or the one movable temperature detection sensor on the single upper plate or the separate upper plate. This combination is based on excellent flatness of the cooking container bottom 6, and the temperature detection sensor is usually installed to be slightly higher than the single upper plate or the separate upper plate.

The adjustment unit 11 collects temperatures from the temperature detection sensors 7, 9, 15, and 21, analyzes or predicts the collected temperatures, and thus adjusts heating power of the heat source part 3 and the temperature of the cooking container 5. Required power of the components including the adjustment unit 11 is input through an electric power inlet 10. A change in temperature of the cooking container 5 compared to input heating power is analyzed by algorithm or artificial intelligence (AI) through the collected temperatures, and thus a target temperature, a target cooking temperature arrival time, a completion cooking time, and the like are predicted. In particular, the adjustment unit 11 may perform automatic cooking while learning a cooking pattern and adjusting the heating power.

The adjustment unit 11 may adjust the heating power of the heat source part 3 and the temperature of the cooking container 5 after analyzing or predicting a higher temperature among the temperatures collected from the two or more temperature detection sensors 7, 9, 15, and 21 installed at a position outside the heat source part 3. Thermal conductivity of the temperature detection sensors 7, 9, 15, and 21 that are not in close contact with the cooking container 5 is lowered, and thus a temperature increase is delayed. Thus, the adjustment unit 11 may predict and select a higher temperature among the temperatures collected from the temperature detection sensors 7, 9, 15, and 21 as an accurate temperature and apply this temperature to the adjustment of the heating power of the heat source part 3 and the temperature of the cooking container 5.

The adjustment unit 11 may reduce the heating power of the heat source part 3 so that a rapid temperature increase of the cooking container 5 is gentle from 95° C. or cut off the electric power of the heat source part 3 upon detecting a state of the temperature that fluctuates up and down, and thus may reduce the overflow of the food. When the temperature of the cooking container 5 increases rapidly, the food may quickly reach the boiling point and overflow the cooking container 5, and thus the adjustment unit 11 may reduce the heating power immediately before reaching 100° C. Further, when the food overflows, the cooking container 5 may be temporarily separated from the temperature detection sensors 7, 9, 15, and 21 due to shaking or the overflowing food may come into contact with the temperature detection sensors 7, 9, 15, and 21, and thus the temperature may decrease. Thus, the adjustment unit 11 may cut off the electric power of the heat source part 3 upon detecting the state of the temperature that fluctuates up and down. In this way, the adjustment of the temperature of the cooking container 5 through the adjustment unit 11 copes with the overflow of the food before or after it happens.

A display unit 12 displays the temperature values of the temperature detection sensors 7, 9, 15, and 21, the analysis or prediction result, a flame state, or a cooking state, which are received from the adjustment unit 11. The analysis or prediction result is all data that may be analyzed or predicted, such as a target cooking temperature arrival time, a boiling point arrival time, and a cooking completion time. The display unit 12 includes a key for operating, cooking, or safety-related operations.

Although some embodiments of the present invention have been illustrated and described, those skilled in the art to which the present invention pertains can implement the present invention in other specific forms without changing the technical spirit, the area, and the essential feature, and thus the embodiments described above should be understood as being illustrative and non-limiting in all aspects. The scope of the present invention is indicated by the appended claims rather than the detailed description, and all changes or modifications derived from the meaning and scope of the appended claims and equivalent concepts thereof should be construed as being included in the scope of the present invention.

1. A temperature-adjusting electric range comprising:
a body forming a frame of a device, having an installation space therein, and including a heat source part configured to heat a cooking container;
a first upper plate configured to cover the body;
a cooling fan disposed under the first upper plate and configured to cool insides of the heat source part and the body;
one or more temperature detection sensors configured to detect a temperature of the cooking container while in contact with the cooking container by being fixedly installed at the same height as or a higher position than the first upper plate while passing through the first upper plate at a position outside the heat source part or by being movably installed to protrude from the first upper plate; and
an adjustment unit configured to collect, analyze, or predict temperatures from the temperature detection sensor and adjust heating power of the heat source part and the temperature of the cooking container.

2. The temperature-adjusting electric range of claim 1, wherein the first upper plate includes a second upper plate of which at least a portion is separated and disposed at a different height,
the cooking container is positioned on the second upper plate and heated, and
the one or more temperature sensors are fixedly installed at the same height as or a higher position than the second upper plate while passing through the first upper plate at a position outside the heat source part or movably installed to protrude from the second upper plate and thus detect the temperature of the cooking container while in contact with the cooking container.

3. The temperature-adjusting electric range of claim 1, comprising one temperature detection sensor configured to detect the temperature of the cooking container while in contact with the cooking container by being fixedly installed at the same height as or a higher position than the first upper plate or the second upper plate while passing through the first upper plate at a position outside the heat source part or by being movably installed to protrude from the first upper plate or the second upper plate.

4. The temperature-adjusting electric range of claim 1, comprising a display unit configured to receive, from the adjustment unit, a temperature value, predicted data, or a cooking situation obtained through the first temperature detection sensor in the body and display the temperature value, the predicted data, or the cooking situation.

5. The temperature-adjusting electric range of claim 1, comprising the adjustment unit configured to adjust the heating power of the heat source part and the temperature of the cooking container after analyzing or predicting a higher temperature among the temperatures collected from the two or more temperature detection sensors.

6. The temperature-adjusting electric range of claim 1, wherein the heating power of the heat source part is reduced so that a rapid temperature increase of the cooking container is gentle from 95° C. or electric power of the heat source part is cut off when a state of the temperature that fluctuates up and down is detected, and thus overflow of food is reduced.

7. The temperature-adjusting electric range of claim 1, wherein an inflow preventing member is fitted between the temperature detection sensor and the first upper plate to prevent food overflowing the cooking container from penetrating into a lower portion of the first upper plate, and thus the temperature detection sensor is fixed to the first upper plate or a body part of the temperature detection sensor moves.

8. The temperature-adjusting electric range of claim 2, wherein a food inflow preventing bank which is higher than the first upper plate and lower than the second upper plate is installed in the first upper plate to prevent food overflowing the cooking container from flowing into a lower portion of the first upper plate, and a body part of the temperature detection sensor moves inside the food inflow preventing bank.
